(19) United States
(12) Patent Application Publication
(10) Pub. No.: US 2023/0394450 A1
(43) Pub. Date: Dec. 7, 2023

(54) SYSTEM AND METHOD FOR STORING AUTOMATED TELLER MACHINE SESSION DATA

(71) Applicant: The Toronto-Dominion Bank, Toronto (CA)

(72) Inventors: A. Warren PRATTEN, London (CA); Graham Allan ANDERSON, Guelph (CA); Anthony Wayne MILES, London (CA)

(73) Assignee: The Toronto-Dominion Bank, Toronto (CA)

(21) Appl. No.: 17/884,193

(22) Filed: Aug. 9, 2022

Related U.S. Application Data
(60) Provisional application No. 63/348,527, filed on Jun. 3, 2022.

(51) Int. Cl. G06Q 20/10; G06Q 20/40

(52) U.S. Cl. CPC G06Q 20/1085; G06Q 20/401

(57) ABSTRACT

A server computer system comprises a communications module; a processor coupled to the communications module; and a memory coupled to the processor, the memory storing processor-executable instructions which, when executed, configure the processor to obtain, via the communications module, automated teller machine session data; generate a first checksum based on at least the automated teller machine session data; and store the first checksum and the automated teller machine session data in a database.

### CROSS-REFERENCE TO RELATED APPLICATIONS

The present application claims the benefit of U.S. Provisional Application No. 63/348,527 filed on Jun. 3, 2022, the entire contents of which are incorporated herein by reference.

### TECHNICAL FIELD

The present application relates to a system and method for storing automated teller machine data.

### BACKGROUND

Automated teller machines (ATMs) allow certain banking services to be performed without resort to a human teller. The banking services may be performed during an automated teller machine session.

A dispute may arise and it may be difficult to determine what operations were performed during a completed automated teller machine session.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified diagram showing components of an example automated teller machine;

FIG. 3 is a logical block diagram of the example automated teller machine of FIG. 2;

FIG. 4 is a high-level operation diagram of an example computing device;

FIG. 5 depicts an example simplified software organization of the example computing device of FIG. 4;

FIG. 6 is a flowchart showing operations performed in storing automated teller machine session data according to an embodiment;

FIG. 7 is a flowchart showing operations performed in aggregating automated teller machine session data;

FIG. 8 is a flowchart showing operations performed in verifying automated teller machine session data; and

FIGS. 9 to 20 show example automated teller machine session data in the form of screenshots, screen stills and images.

Like reference numerals are used in the drawings to denote like elements and features.

### DETAILED DESCRIPTION OF VARIOUS EMBODIMENTS

Accordingly, in one aspect there is provided a server computer system comprising a communications module; a processor coupled to the communications module; and a memory coupled to the processor, the memory storing processor-executable instructions which, when executed, configure the processor to obtain, via the communications module, automated teller machine session data; generate a first checksum based on at least the automated teller machine session data; and store the first checksum and the automated teller machine session data in a database.

In one or more embodiments, the processor-executable instructions, when executed, further configure the processor to receive a request to verify the automated teller machine session data; retrieve the first checksum and the automated teller machine session data from the database; and generate a second checksum based on the retrieved automated teller machine session data; and compare the first checksum to the second checksum to verify the automated teller machine session data.

In one or more embodiments, the processor-executable instructions, when executed, further configure the processor to determine that the first checksum and the second checksum match; and responsive to determining that the first checksum and the second checksum match, verify that the automated teller machine session data has not been tampered with.

In one or more embodiments, the processor-executable instructions, when executed, further configure the processor to determine that the first checksum and the second checksum do not match; and responsive to determining that the first checksum and the second checksum do not match, determine that the automated teller machine session data has been tampered with.

In one or more embodiments, the automated teller machine session data is obtained, via the communications module, from at least one automated teller machine data source that includes at least one of an automated teller machine, an automated teller machine switch, and an automated teller machine host server.

In one or more embodiments, the at least one automated teller machine data source is a plurality of automated teller machine data sources and the processor-executable instructions, when executed, further configure the processor to normalize and aggregate the automated teller machine session data.

In one or more embodiments, when aggregating the automated teller machine session data, the processor-executable instructions, when executed, further configure the processor to analyze the automated teller machine session data to identify at least one commonality within the automated teller machine session data received from each of the automated teller machine data sources; and aggregate the automated teller machine session data based at least on the identified commonality.

In one or more embodiments, the at least one commonality includes at least one of a transaction identifier, a time, a date, an automated teller machine identifier, a customer identifier, or an account identifier.

In one or more embodiments, the processor-executable instructions, when executed, further configure the processor to receive, in real-time and via the communications module from each one of the plurality of automated teller machine data sources, a signal indicating an end of an automated teller machine session; and aggregate the automated teller machine session data based at least on the signal indicating the end of the automated teller machine session.

In one or more embodiments, the processor-executable instructions, when executed, further configure the processor to obtain, via the communications module, mobile application data; aggregate the mobile application data and the automated teller machine session data; generate the first checksum based on the automated teller machine session data and the mobile application data; and store the first checksum, the mobile application data and the automated teller machine session data in the database.

In one or more embodiments, the automated teller session data includes at least one of automated teller machine screen shots, automated teller machine fault logs, automated teller machine receipts, automated teller machine deposits, cheque images, automated teller machine video, automated teller machine identifiers, surveillance video, surveillance images, or financial transaction data.

According to another aspect there is provided a computer-implemented method performed by a processor of a server computer system, the method comprising obtaining, via a communications module, automated teller machine session data; generating a first checksum based on at least the automated teller machine session data; and storing the first checksum and the automated teller machine session data in a database.

In one or more embodiments, the method further comprises receiving a request to verify the automated teller machine session data; retrieving the first checksum and the automated teller machine session data from the database; generating a second checksum based on the retrieved automated teller machine session data; and comparing the first checksum to the second checksum to verify the automated teller machine session data.

In one or more embodiments, the automated teller machine session data is obtained, via the communications module, from at least one automated teller machine data source that includes at least one of an automated teller machine, an automated teller machine switch, and an automated teller machine host server.

In one or more embodiments, the at least one automated teller machine data source is a plurality of automated teller machine data sources and the computer-implemented method further comprises normalizing and aggregating the automated teller machine session data.

In one or more embodiments, when aggregating the automated teller machine session data, the computer-implemented method further comprises analyzing the automated teller machine session data to identify at least one commonality within the automated teller machine session data received from each of the automated teller machine data sources; and aggregating the automated teller machine session data based at least on the identified commonality.

In one or more embodiments, the at least one commonality includes at least one of a transaction identifier, a time, a date, an automated teller machine identifier, a customer identifier, or an account identifier.

In one or more embodiments, the method further comprises receiving, in real-time and via the communications module from each one of the plurality of automated teller machine data sources, a signal indicating an end of an automated teller machine session; and aggregating the automated teller machine session data based at least on the signal indicating the end of the automated teller machine session.

In one or more embodiments, the method further comprises obtaining, via the communications module, mobile application data; aggregating the mobile application data and the automated teller machine session data; generating the first checksum based on the automated teller machine session data and the mobile application data; and storing the first checksum, the mobile application data and the automated teller machine session data in the database.

According to another aspect there is provided a non-transitory computer-readable storage medium storing instructions that when executed by a processor of a computing system cause the computing system to obtain, via a communications module, automated teller machine session data; generate a first checksum based on at least the automated teller machine session data; and store the first checksum and the automated teller machine session data in a database.

Aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

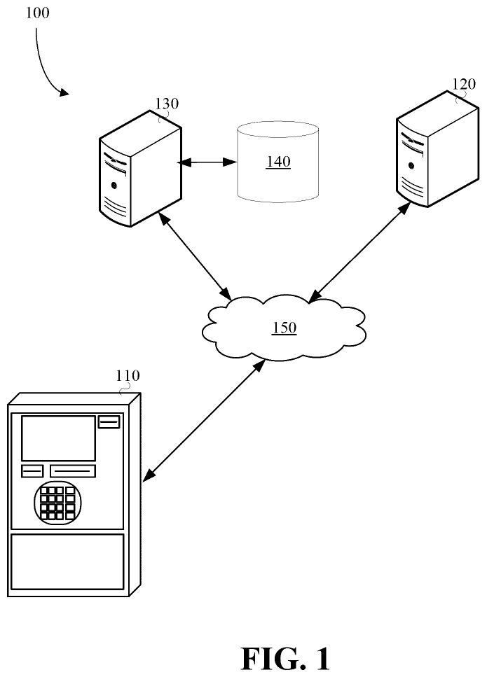

FIG. 1 is a schematic operation diagram illustrating an operating environment of an example embodiment. As shown, a system 100 includes an automated teller machine 110, an automated teller machine switch 120, and a server computer system 130 coupled to one another through a network 150, which may include a public network such as the Internet and/or a private network. The automated teller machine 110, the automated teller machine switch 120, and the server computer system 130 may be in geographically disparate locations. Put differently, the automated teller machine 110, the automated teller machine switch 120, and the server computer system 130 may be located remote from one another.

The automated teller machine 110 may be associated with a financial institution. The automated teller machine 110 is adapted to provide access to banking services such as, for example, withdrawals and deposits. The automated teller machine 110 is configured to capture images of at least some of the value instruments it receives.

The automated teller machine switch 120 and the server computer system 130 are computer server systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The automated teller machine switch 120 may be adapted to broker (e.g., relay) communication between the automated teller machine 110 and a payment network (not shown). The automated teller machine switch 120 may perform operations related to performing transactions using the automated teller machine 110. For example, the automated teller machine switch 120 may perform operations related to authorizing and/or completing transactions based on cheques deposited at the automated teller machine 110. The automated teller machine switch 120 may additionally or alternatively perform operations related to authenticating a user of the automated teller machine 110. For example, the automated teller machine switch 120 may perform operations to authenticate a user based on data from a card used to access the automated teller machine 110 and based on a personal identification number (PIN) received as input by the automated teller machine 110.

The server computer system 130 may be associated with a financial institution and the financial institution may be the same financial institution associated with the automated teller machine 110.

The server computer system 130 may be associated with or may communicate with a database 140 that stores data records. The data records may include automated teller machine session data and checksums generated based off associated automated teller machine session data.

As will be described in more detail below, the server computer system 130 may obtain automated teller machine session data, generate a first checksum based on the automated teller machine session data, and store the automated teller machine session data and the first checksum in the database 140 such that the automated teller machine session data may be retrieved and verified using the first checksum.

The network 150 is a computer network. In some embodiments, the network 150 may be an internetwork such as may be formed of one or more interconnected computer networks. For example, the network 150 may be or may include an Ethernet network, an asynchronous transfer mode (ATM) network, a wireless network, a telecommunications network, or the like.

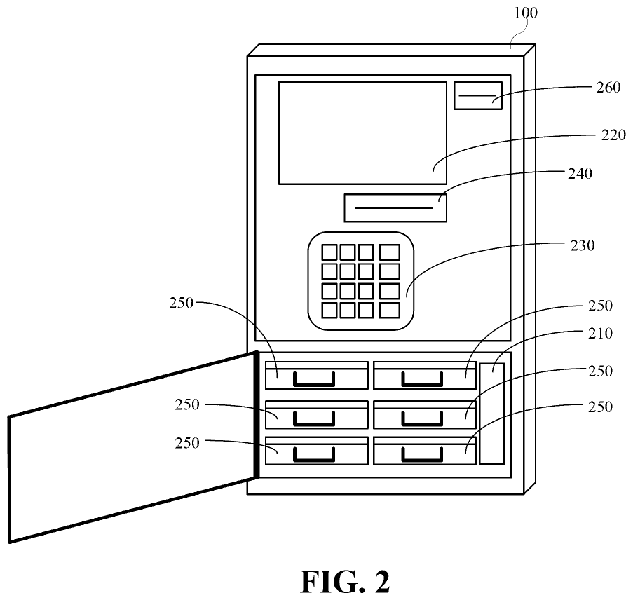

FIG. 2 illustrates example components of the automated teller machine 110. The automated teller machine 110 is adapted to provide access to banking services such as for example withdrawals and deposits. As shown in FIG. 2, the automated teller machine 110 includes a controller 210, a display 220, a keypad 230, an item receiver/dispenser 240, cassettes 250, and a card reader 260.

As further described below, the controller 210 is a computing device. For example, the controller 210 may include a processor that executes instructions retrieved from a computer-readable medium thereby causing the automated teller machine 110 to perform operations for providing access to banking services.

The display 220 may for example, be a liquid-crystal display (LCD), a cathode-ray tube (CRT), or the like. The display 220 may present a user interface to a user of the automated teller machine 110.

The keypad 230 is an input device allowing input to be provided to the automated teller machine 110. Input received via the keypad 230 may be conveyed to the controller 210. The keypad 230 may be used by a user to provide a personal identification number (PIN) to the automated teller machine 110 as a part of authenticating to the automated teller machine 110.

The item receiver/dispenser 240 is a device allowing value instruments to be received by the automated teller machine 110 or dispensed by the automated teller machine 110. The value instruments may include banknotes and/or cheques. The item receiver/dispenser 240 may provide a single slot through which value instruments may be dispensed. Additionally or alternatively, the item receiver/dispenser 240 may provide multiple slots. It may be that components or units of the item receiver/dispenser 240 are specialized to a particular type or types of value instrument. For example, a particular component or unit of the item receiver/dispenser 240 may be adapted to receiving and/or dispensing banknotes of one denomination, while another component or unit may be adapted to receiving and/or dispensing banknotes of another denomination. Alternatively, it may be that the item receiver/dispenser 240 is a monolithic unit that handles all manner of value instruments.

As mentioned above, the automated teller machine includes one or more cassettes 250. The item receiver/dispenser 240 may be in communication with the cassettes 250. Some or all of the cassettes 250 may be adapted to dispense value instruments. For example, some of the cassettes 250 may be for dispensing banknotes of particular denominations.

The item receiver/dispenser 240 and the cassettes 250 may be collectively considered a value instrument dispenser adapted to dispense value instruments such as to satisfy withdrawals from the automated teller machine 110.

The card reader 260 allows data to be read from a card or access card such as for example a common ISO-sized ATM or cheque card. For example, the card reader 260 may allow data to be read from magnetic stripe cards and/or chip cards. In some embodiments, the card reader 260 may require a card to be swiped through it to be read (a so-called “swipe reader”) and/or it may allow a card to be inserted into it for reading (a so-called “dip reader”). In some embodiments, the card reader 260 may be adapted to allow inserted cards to be retained by the automated teller machine 110 indefinitely (such as if fraud is suspected) and/or for the period of a session.

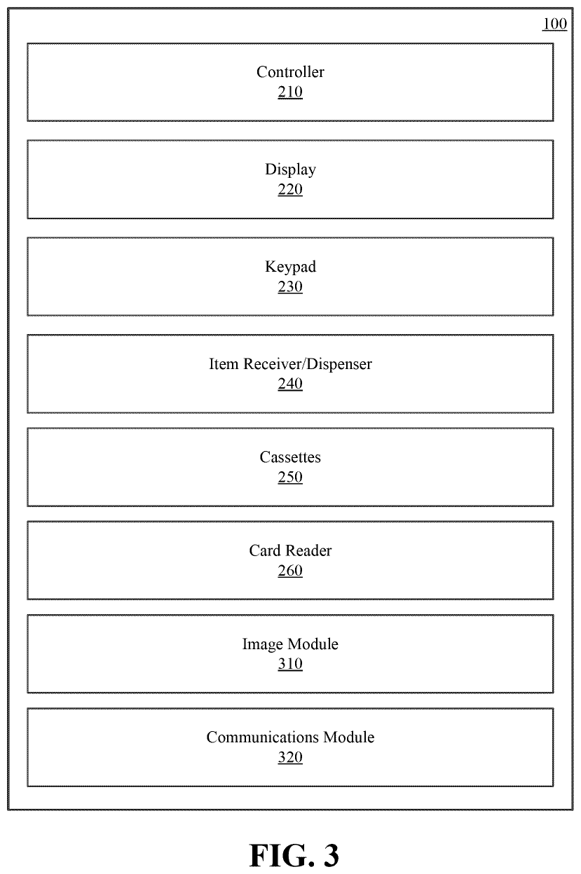

FIG. 3 is a logical block diagram of the automated teller machine 110. As described above, the automated teller machine 110 may include a controller 210, a display 220, a keypad 230, an item receiver/dispenser 240, cassettes 250, and a card reader 260 as described above. Additionally, as shown in FIG. 3, the automated teller machine 110 may include an image module 310 and a communications module 320.

The image module 310 is adapted to scan or capture images of value instruments received by the automated teller machine 110. For example, the image module 310 may scan or capture images of value instruments (such as, for example, bank notes, negotiable instruments like cheques, money orders, bank drafts, warrants of payment, etc.) as they are received by the automated teller machine 110 such as, for example, by way of the item receiver/dispenser 240. The image module 310 may include a colour, black and white, or a grayscale scanner. In one or more embodiments, image module 310 may include an ultraviolet scanner and the ultraviolet scanner may be engaged to identify security features for counterfeit detection. The image module 310 may include a number of scanning technologies. For example, the image module 310 may include a contact image sensor (CIS), a charge-coupled device (CCD), etc.

The communications module 320 allows the automated teller machine 110 to communicate with other computing devices and/or various communications networks such as, for example, the network 150. In other words, the communications module 320 may allow the automated teller machine 110 to send or receive communications signals. Communications signals may be sent or received according to one or more protocols or according to one or more standards. For example, the communications module 320 may allow the automated teller machine 110 to communicate via an Ethernet network, an ATM network, a telephone network, and/or via cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 320 may allow the automated teller machine 110 to communicate using near-field communication (NFC), via Wi-Fi™, using Bluetooth™ or via some combination of one or more networks or protocols.

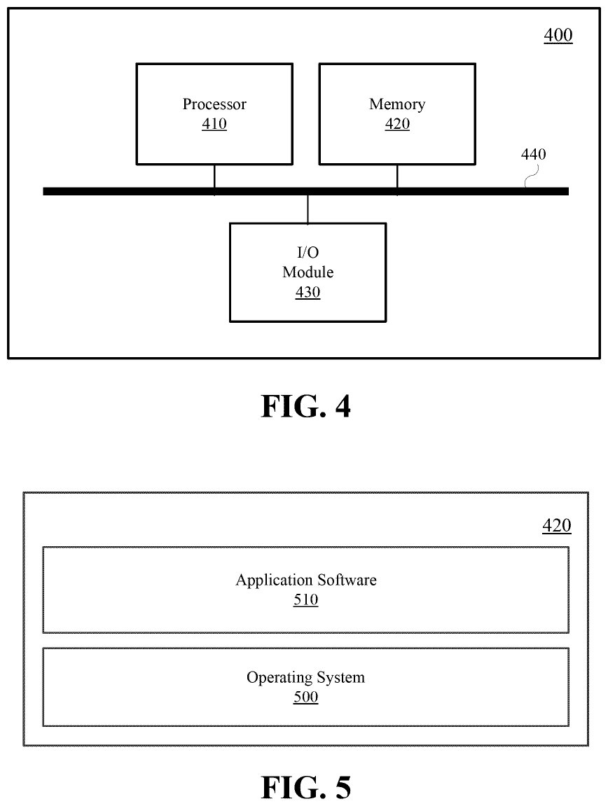

FIG. 4 is a high-level operation diagram of an example computing device 400. In some embodiments, the example computing device 400 may be exemplary of the controller 210 (FIG. 2), the automated teller machine switch 120 and/or the server computer system 130. Each of the automated teller machine 110, the automated teller machine switch 120 and the server computer system 130 include software that adapts it to perform a particular function.

The example computing device 400 includes a variety of modules. For example, as illustrated, the example computing device 400 may include a processor 410, a memory 420, and an input/output (I/O) module 430. As illustrated, the foregoing example modules of the example computing device 400 are in communication over a bus 440.

The processor 410 is a hardware processor. The processor 410 may, for example, be one or more ARM, Intel x86, PowerPC processors or the like.

The memory 420 allows data to be stored and retrieved. The memory 420 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computing device 400.

The I/O module 430 allows the example computing device 400 to interact with devices such as, for example, peripherals to send and receive data. The I/O module 430 may, for example, allow the example computing device 400 to interface with input devices such as, for example, keypads, keyboards, pointing devices, and the like. In another example, the I/O module 430 may, for example, allow the example computing device 400 to interface with output devices such as, for example, displays, printers, and the like. In a particular example, where the example computing device 400 forms a part of the automated teller machine 110 (FIG. 1) such as, for example, if the example computing device 400 is or forms a part of the controller 210 (FIG. 2) of the automated teller machine 110, the I/O module 430 may allow the example computing device 400 to interface with, for example, one or more of the display 220, the keypad 230, the item receiver/dispenser 240, cassettes 250, the card reader 260, the image module 310 and/or the communications module 320.

Software comprising instructions is executed by the processor 410 from a computer-readable medium. For example, software may be loaded into random-access memory from persistent storage of the memory 420. Additionally, or alternatively, instructions may be executed by the processor 410 directly from read-only memory of the memory 420.

FIG. 5 depicts a simplified organization of software components stored in the memory 420 of the example computing device 400 (FIG. 4). As illustrated, these software components include an operating system 500 and application software 510.

The operating system 500 is software. The operating system 500 allows the application software 510 to access the processor 410, the memory 420, and the I/O module 430 of the example computing device 400 (FIG. 4). The operating system 500 may be, for example, Google™ Android™, Apple™ iOS™, UNIX™, Linux™, Microsoft™ Windows™, Apple OSX™ or the like.

The application software 510 adapts the example computing device 400, in combination with the operating system 500, to operate as a device performing a particular function. For example, the application software 510 may cooperate with the operating system 500 to adapt a suitable embodiment of the example computing device 400 to operate as the controller 210 (FIG. 2) of the automated teller machine 110 (FIG. 1).

Operations performed by the automated teller machine 110 will now be described.

The automated teller machine 110 may perform one or more tasks associated with an account. Prior to performing the one or more tasks, the automated teller machine 110 may require a user to authenticate using, for example, an authentication token. Authentication may include receiving an indication of an authentication token and authenticating the authentication token. In one or more embodiments, authenticating may require two-factor authentication. For example, in one or more embodiments, the automated teller machine 110 may require the user to enter a PIN associated with the card that was inserted into the card reader 260. The user may enter the PIN using, for example, the keypad 230 of the automated teller machine 110. Responsive to receiving the PIN, the automated teller machine 110 may determine that the PIN is indeed associated or linked with the card. Once authenticated, the automated teller machine 110 may identify an account associated with the authentication token.

Once authentication has been completed, an automated teller machine session begins. During the automated teller machine session, the automated teller machine 110 may perform one or more tasks associated with the account. The tasks may include depositing funds, withdrawing funds, determining an account balance, etc.

During the automated teller machine session, the automated teller machine 110 may log and store automated teller machine session data. The automated teller machine session data may include one or more of data indicating actions performed by the customer at the automated teller machine 110 and in what order, screen shots of images presented to the customer during the automated teller machine session such as for example a screen shot showing the presentation of a disclosure statement, images of cheque deposits, data indicating hardware or software faults that took place at the automated teller machine 110 during the automated teller machine session, the automated teller machine 110 terminal identification, a time of the automated teller machine session, a date of the automated teller machine session, a customer identifier, account identifiers, amounts of funds withdrawn or deposited during the automated teller machine session, data indicating customer decisions made based on the presented disclosure screens, and/or an image of a transaction receipt (regardless of whether or not the customer has requested a receipt) for one or more transactions completed during the automated teller machine session. The automated teller machine session data is logged from the beginning of the automated teller machine session (once authentication has been completed) to the end of the automated teller machine session (when the card has been returned to the customer).

The server computer system 130 may obtain and store the automated teller machine session data.

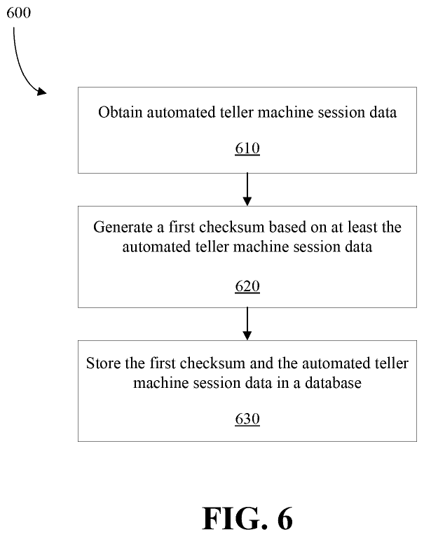

Reference is made to FIG. 6, which illustrates, in flowchart form, a method 600 for storing automated teller machine session data. The method 600 may be implemented by a computing device having suitable processor-executable instructions for causing the computing device to carry out the described operations. The method 600 may be implemented, in whole or in part, by the server computer system 130.

The method 600 includes obtaining automated teller machine session data (step 610).

In one or more embodiments, the automated teller machine data may be obtained via the network 150 from a single source and the single source may include the automated teller machine 110. As mentioned, the automated teller machine session data may include one or more of data indicating actions performed by the customer at the automated teller machine 110 and in what order, screen shots of images presented to the customer during the automated teller machine session such as for example a screen shot showing the presentation of a disclosure statement, images of cheque deposits, data indicating hardware or software faults that took place at the automated teller machine 110 during the automated teller machine session, the automated teller machine 110 terminal identification, a time of the automated teller machine session, a date of the automated teller machine session, a customer identifier, account identifiers, amounts of funds withdrawn or deposited during the automated teller machine session, data indicating customer decisions made based on the presented disclosure screens, and/or an image of a transaction receipt (regardless of whether or not the customer has requested a receipt) for one or more transactions completed during the automated teller machine session.

In one or more embodiments, the automated teller machine session data may be obtained from the single source at the end of an automated teller machine session. For example, an automated teller machine session may begin when a card is inserted into the automated teller machine 110 and the automated teller machine session may end when the card is returned by the automated teller machine 110. As another example, an automated teller machine session may begin once authentication has been completed (as described above) and may end when the card is returned by the automated teller machine 110.

In one or more embodiments, the automated teller machine session data may be sent to the server computer system 130 in batches. For example, the automated teller machine 110 may send automated teller machine session data to the server computer system 130 at the end of every hour, every day, etc. In this example, the automated teller machine session data may include automated teller machine session data for a plurality of automated teller machine sessions.

In one or more embodiments, the automated teller machine session data may be obtained via the network 150 from a plurality of automated teller machine session data sources. The plurality of automated teller machine data sources may include an automated teller machine, an automated teller machine switch and/or an automated teller machine host server.

In one or more embodiments, automated teller machine session data obtained from the automated teller machine may include one or more of data indicating actions performed by the customer at the automated teller machine 110 and in what order, screen shots of images presented to the customer during the automated teller machine session such as for example a screen shot showing the presentation of a disclosure statement, images of cheque deposits, data indicating hardware or software faults that took place at the automated teller machine 110 during the automated teller machine session, the automated teller machine 110 terminal identification, a time of the automated teller machine session, a date of the automated teller machine session, a customer identifier, account identifiers, amounts of funds withdrawn or deposited during the automated teller machine session, data indicating customer decisions made based on the presented disclosure screens, and/or an image of a transaction receipt (regardless of whether or not the customer has requested a receipt) for one or more transactions completed during the automated teller machine session.

In one or more embodiments, automated teller machine session data obtained from the automated teller machine switch may include financial transaction data based on communications exchanged via the automated teller machine switch. The financial transaction data may include, for example, data indicating whether a transaction was approved or denied, a service charge applied for a transaction, an exchange rate used to complete a transaction, etc.

In one or more embodiments, automated teller machine session data obtained from the automated teller machine host server may include financial transaction data based on communications exchanged via the automated teller machine host server. The financial transaction data may include, for example, data indicating whether a transaction was approved or denied, a service charge applied for a transaction, an exchange rate used to complete a transaction, etc.

It will be appreciated that the automated teller machine session data obtained from the automated teller machine switch may align with the automated teller machine session data obtained from the automated teller machine host server.

The automated teller machine session data may additionally be obtained from, for example, a security server computer system. In this example, the automated teller machine session data may include surveillance video or surveillance images taken by one or more security cameras located in proximity with the automated teller machine 110.

In embodiments where the server computer system 130 obtains automated teller machine session data from a plurality of automated teller machine session data sources, the server computer system 130 may analyze the automated teller machine session data to normalize and aggregate the automated teller machine session data for each automated teller machine session.

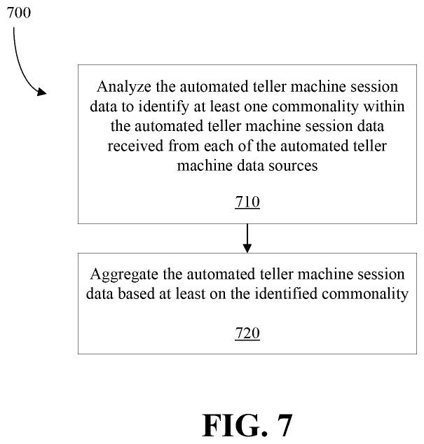

Reference is made to FIG. 7, which illustrates, in flowchart form, a method 700 for aggregating automated teller machine session data. The method 700 may be implemented by a computing device having suitable processor-executable instructions for causing the computing device to carry out the described operations. The method 700 may be implemented, in whole or in part, by the server computer system 130.

The method 700 includes analyzing the automated teller machine session data to identify at least one commonality within the automated teller machine session data received from each of the automated teller machine data sources (step 710).

The server computer system 130 analyzes the automated teller machine session data received from the plurality of automated teller machine session data sources to identify at least one commonality. The at least one commonality may include one or more of a transaction identifier, a time, a date, an automated teller machine identifier, a customer identifier, or an account identifier. The at least one commonality may be identified, for example, by analyzing metadata associated with the automated teller machine session data or may be identified directly from the automated teller machine session data.

In one or more embodiments, automated teller machine session data received from one or more of the automated teller machine session data sources may not have the same commonality as other automated teller machine session data sources. For example, the server computer system 130 may identify a commonality such as a transaction identifier in automated teller machine session data obtained from the automated teller machine, the automated teller machine switch, and the automated teller machine host server. The transaction identifier may not however be available for the automated teller machine session data obtained from the security server computer system. However, the time and the date may be obtained from the automated teller machine session data obtained from the security server computer system and as such the time and the date may be used to aggregate the automated teller machine session data obtained from the security server computer system with the automated teller machine session data obtained from the automated teller machine, the automated teller machine switch, and the automated teller machine host server.

The method 700 includes aggregating the automated teller machine session data based at least on the identified commonality (step 720).

The automated teller machine session data identified is aggregated for the automated teller machine session. In one or more embodiments, aggregating the automated teller machine session data may include generating a data file that includes all the automated teller machine session data obtained for the automated teller machine session. The data file may include a compressed data file that may be generated using a data compression engine that utilizes one or more data compression algorithms.

The method 600 includes generating a first checksum based on at least the automated teller machine session data (step 620).

The first checksum may be generated by a checksum engine that utilizes an algorithm to generate a hash value on the automated teller machine session data.

In one or more embodiments, the algorithm may include an MD5 message-digest algorithm and the hash value may include a 128-bit hash value. The 128-bit MD5 hash value may be represented as a sequence of 32 hexadecimal digits. It will be appreciated that the hash value is generated such that it is unique to the automated teller machine session data and that even a small change to the automated teller machine session data will result in a different hash value.

It will be appreciated that other algorithms may be utilized such as for example or an MD6 message-digest algorithm, secure hash algorithm 2 (SHA-2), etc.

The method 600 includes storing the first checksum and the automated teller machine session data in a database (step 630).

The database may include the database 140. The first checksum is stored in the database in association with the automated teller machine session data. The first checksum and the automated teller machine session data may be stored in association with an identifier such as for example a particular account, transaction identifier, etc. and this may be based on the commonality used to aggregate the automated teller machine session data as described above. It will be appreciated that the identifier may be based on something other that the commonality. For example, a customer account may be identified by analyzing the automated teller machine session data obtained from the automated teller machine.

The data is stored in the database or data store with data classifications, data retention policies, data backup policies, and access authorizations and this may be done in accordance with security policies implemented by the financial institution associated therewith.

The first checksum may be used to ensure that the automated teller machine session data has not been tampered with since it was obtained by the server computer system 130. For example, customer disputes or other potential issues related to tasks performed by the automated teller machine 110 may be resolved as the automated teller machine session data is stored in a manner such that it cannot be tampered be. Put another way, the first checksum may be used to verify the automated teller machine session data.

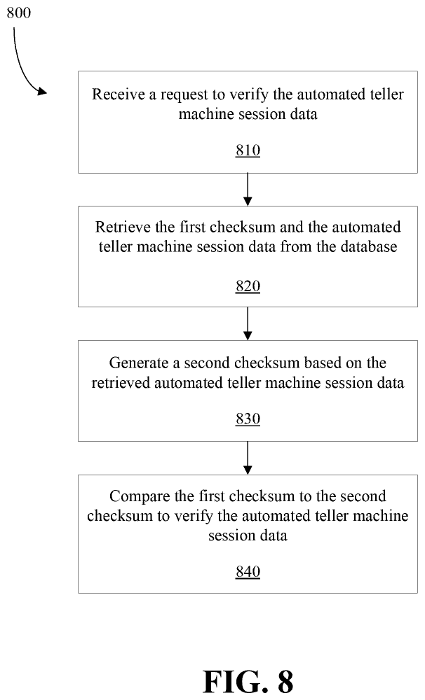

Reference is made to FIG. 8, which illustrates, in flowchart form, a method 800 for verifying automated teller machine session data. The method 800 may be implemented by a computing device having suitable processor-executable instructions for causing the computing device to carry out the described operations. The method 800 may be implemented, in whole or in part, by the server computer system 130.

The method 800 includes receiving a request to verify the automated teller machine session data (step 810).

The request may be received from a computing system connected to the server computer system 130 and/or from an operator of the server computer system 130. The request may include the identifier associated with the automated teller machine session data and the first checksum.

In one or more embodiments, it will be appreciated that the server computer system 130 may include a software application that may be used to search the database 140. For example, the software application may allow an operator to search through automated teller machine session data by automated teller machine identifier, customer, account, date, time, etc. and this may be used to locate the automated teller machine data and to generate the request to verify the automated teller machine session data.

The method 800 includes retrieving the first checksum and the automated teller machine session data from the database (step 820).

The server computer system 130 obtains the first checksum and the automated teller machine session data from the database based on the request. For example, the identifier included with the request may be used to retrieve the first checksum and the automated teller machine session data from the database.

The method 800 includes generating a second checksum based on the retrieved automated teller machine session data (step 830).

The hash value that is the second checksum may be generated by a checksum engine that utilizes an algorithm to generate the hash value on the retrieved automated teller machine session data. The checksum engine is the same checksum engine that generated the first checksum. Put another way, the second checksum is generated using the same algorithm that was used to generate the first checksum.

The method 800 includes comparing the first checksum to the second checksum to verify the automated teller machine session data (step 840).

As mentioned, the hash value that is the first checksum is generated such that it is unique to the automated teller machine session data and that even a small change to the automated teller machine session data will result in a different hash value. As such, by comparing the first checksum to the second checksum, it may be determined whether or not the automated teller machine session data has been tampered with since it was first stored in the database 140.

For example, it may be determined that the first checksum and the second checksum match and as such it is determined that the automated teller machine session data has not been tampered with. In this example, the automated teller machine session data is verified.

As another example, it may be determined that the first checksum and the second checksum do not match and as such it determined that the automated teller machine session data has been tampered with. In this example, the automated teller machine session data is not verified.

In manners described herein, the automated teller machine session data may be retrieved and verified and may be used to resolve disputes that may arise.

As one example, a customer may raise a dispute indicating that they requested $100 from the automated teller machine 110 but only received $50 or may raise a dispute indicating that they deposited three (3) cheques with a total value of $300 but the automated teller machine 110 only deposited $200 into their account. In this example, the automated teller machine session data may be retrieved and verified from the database 140 and may then be reviewed to resolve the dispute.

As another example, the automated teller machine 110 may have applied potentially inappropriate or inaccurate service fees or foreign exchange premiums for transactions that rely on dynamic currency conversion or multi-currency dispensing. In this example, the automated teller machine session data may be retrieved and verified from the database 140 and may then be reviewed to resolve the potentially inappropriate or inaccurate service fees.

As yet another example, the automated teller machine session data may be stored as evidence of compliance to regulatory or contractual agreements with partners such as for example MasterCard™, VISA™, INTERAC™, etc.

Although in embodiments described herein, the first checksum is described as being generated based on automated teller machine session data, it will be appreciated that other types of data may be aggregated with the automated teller machine session data prior to generation of the first checksum. For example, in one or more embodiments, mobile application data may be obtained and aggregated with the automated teller machine session data. The first checksum may be generated based on the automated teller machine session data and the mobile application data. The first checksum, the mobile application data and the automated teller machine session data may then be stored in the database. In these embodiments, the mobile application data may include data obtained from a mobile banking mobile application or website that includes permissions granted within the mobile banking mobile application or website. The permissions may include, for example, a parent granting permission to their child to withdraw money from the automated teller machine 110. In this manner, the mobile application data may be retrieved together with the automated teller machine session data to resolve disputes.

As one example, a parent may raise a dispute based on their child withdrawing $100 from the automated teller machine 110. In this example, the automated teller machine session data and the mobile application data may be retrieved from the database 140 and analyzed to determine whether or not the parent had used the mobile banking mobile application or website to grant permission to their child to withdraw the $100 from the automated teller machine 110.

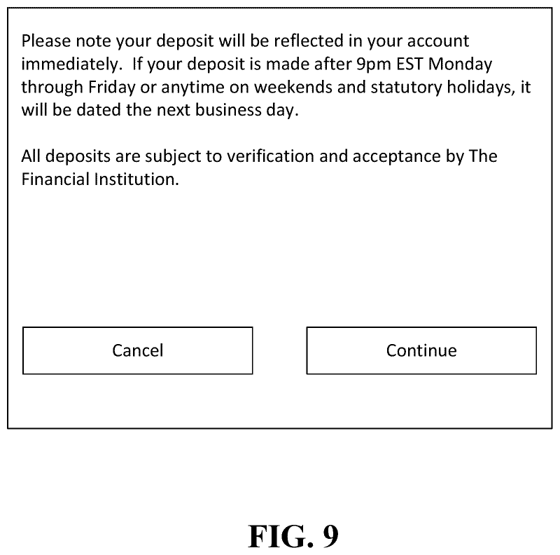

As mentioned, the customer session transaction records may include screenshots, screen stills, images such as images of a cheque deposit, transaction receipt, etc. relating to tasks performed by the automated teller machine 110. Example screenshots, screen stills and images are shown in FIGS. 9 to 20.

Specifically, FIG. 9 is a screenshot that may be displayed during an automated teller machine session to receive customer acceptance of a disclosure statement. It will be appreciated that the automated teller machine session data may include the screenshot and data indicating which decision the customer made (continue or cancel).

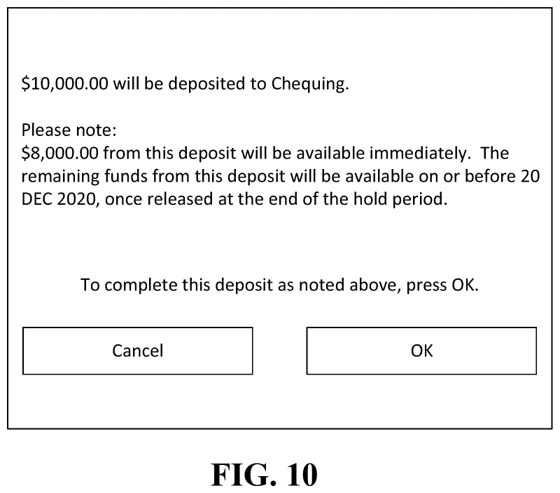

FIG. 10 is a screenshot that may be displayed during an automated teller machine session to receive customer acceptance of a disclosure statement. It will be appreciated that the automated teller machine session data may include the screenshot and data indicating which decision the customer made (“ok” or cancel).

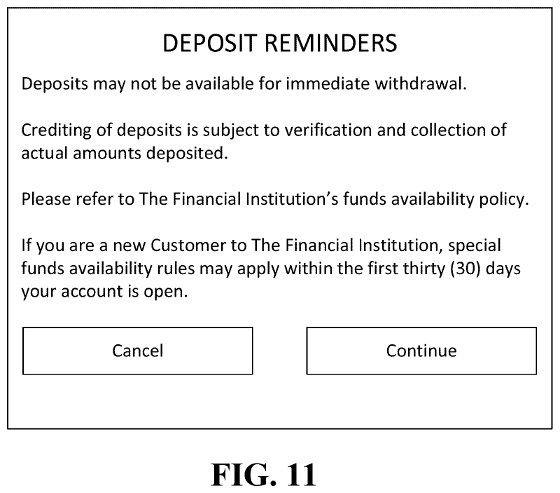

FIG. 11 is a screenshot that may be displayed during an automated teller machine session to receive customer acceptance of a disclosure statement. It will be appreciated that the automated teller machine session data may include the screenshot and data indicating which decision the customer made (continue or cancel).

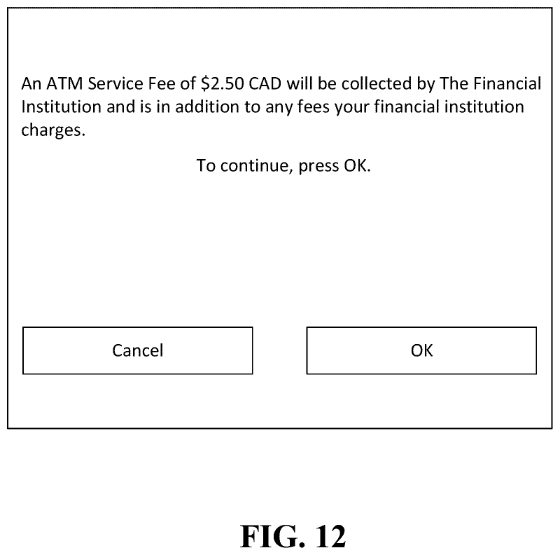

FIG. 12 is a screenshot that may be displayed during an automated teller machine session to receive customer acceptance of a service fee. It will be appreciated that the automated teller machine session data may include the screenshot and data indicating which decision the customer made (“ok” or cancel).

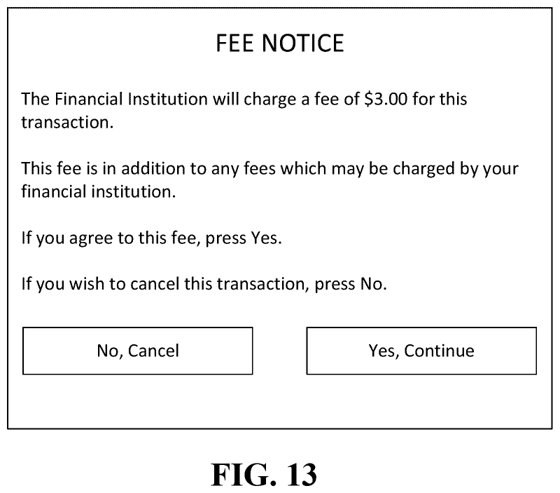

FIG. 13 is a screenshot that may be displayed during an automated teller machine session to receive customer acceptance of a service fee. It will be appreciated that the automated teller machine session data may include the screenshot and data indicating which decision the customer made (“no, cancel” or “yes, continue”).

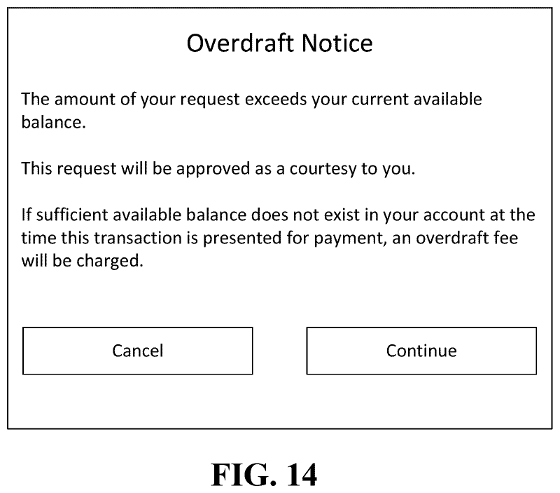

FIG. 14 is a screenshot that may be displayed during an automated teller machine session to receive customer acceptance of an overdraft fee. It will be appreciated that the automated teller machine session data may include the screenshot and data indicating which decision the customer made (cancel or continue).

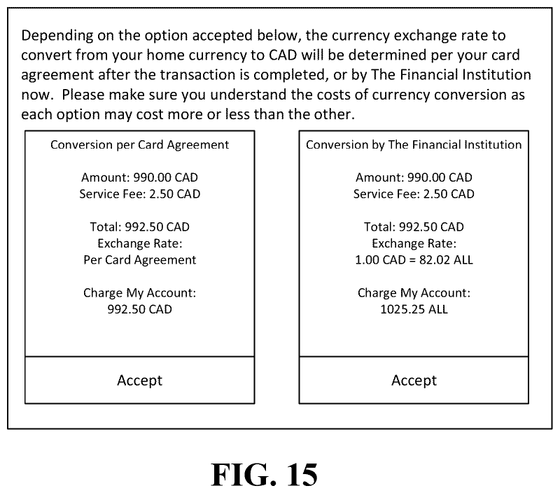

FIG. 15 is a screenshot that may be displayed during an automated teller machine session to receive customer selection of an exchange rate. It will be appreciated that the automated teller machine session data may include the screenshot and data indicating which decision the customer made (conversion per card agreement or conversion by the financial institution).

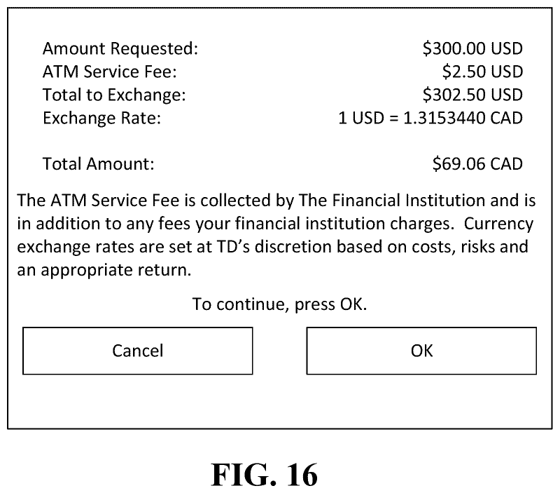

FIG. 16 is a screenshot that may be displayed during an automated teller machine session to receive customer acceptance of an exchange rate and service fee. It will be appreciated that the automated teller machine session data may include the screenshot and data indicating which decision the customer made (cancel or “ok”).

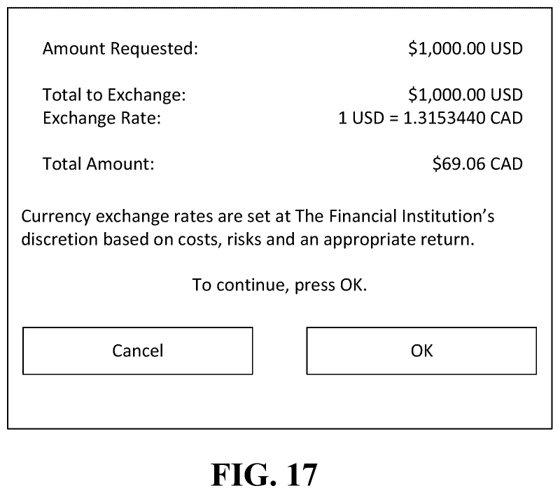

FIG. 17 is a screenshot that may be displayed during an automated teller machine session to receive customer acceptance of an exchange rate. It will be appreciated that the automated teller machine session data may include the screenshot and data indicating which decision the customer made (cancel or “ok”).

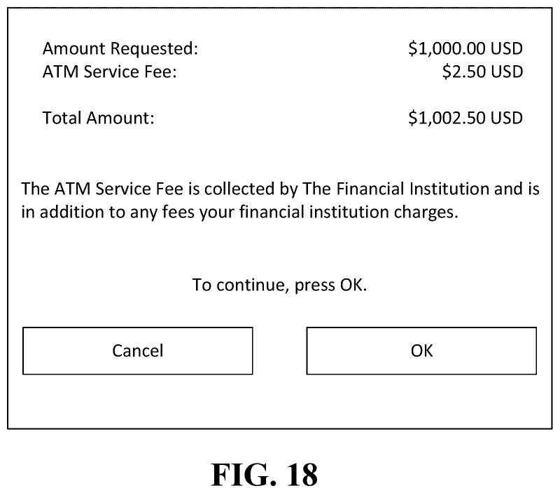

FIG. 18 is a screenshot that may be displayed during an automated teller machine session to receive customer acceptance of a service fee. It will be appreciated that the automated teller machine session data may include the screenshot and data indicating which decision the customer made (“cancel or “ok”).

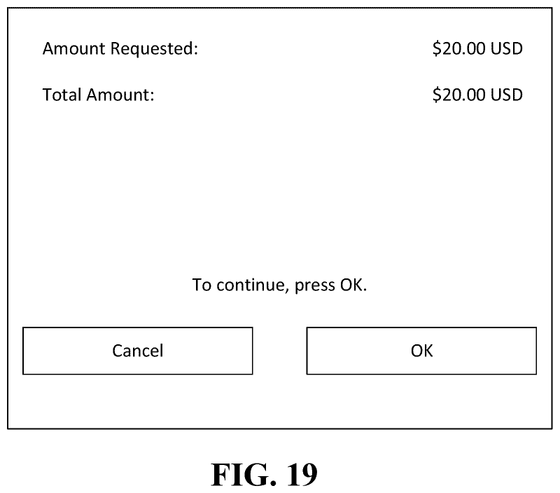

FIG. 19 is a screenshot that may be displayed during an automated teller machine session to receive customer confirmation of a withdrawal. It will be appreciated that the automated teller machine session data may include the screenshot and data indicating which decision the customer made (“cancel or “ok”).

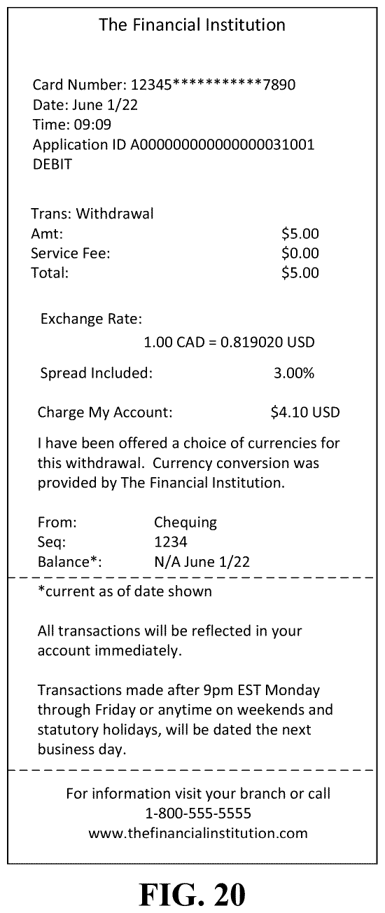

FIG. 20 is an image of a receipt that may be provided to a customer at the end of an automated teller machine session. The automated teller machine session data may include the image of the receipt.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A server computer system comprising:
a communications module;
a processor coupled to the communications module; and
a memory coupled to the processor, the memory storing processor-executable instructions which, when executed, configure the processor to:
obtain, via the communications module, automated teller machine session data;
generate a first checksum based on at least the automated teller machine session data; and
store the first checksum and the automated teller machine session data in a database.

2. The server computer system of claim 1, wherein the processor-executable instructions, when executed, further configure the processor to:
receive a request to verify the automated teller machine session data;
retrieve the first checksum and the automated teller machine session data from the database; and
generate a second checksum based on the retrieved automated teller machine session data; and
compare the first checksum to the second checksum to verify the automated teller machine session data.

3. The server computer system of claim 2, wherein the processor-executable instructions, when executed, further configure the processor to:
determine that the first checksum and the second checksum match; and
responsive to determining that the first checksum and the second checksum match, verify that the automated teller machine session data has not been tampered with.

4. The server computer system of claim 2, wherein the processor-executable instructions, when executed, further configure the processor to:
determine that the first checksum and the second checksum do not match; and
responsive to determining that the first checksum and the second checksum do not match, determine that the automated teller machine session data has been tampered with.

5. The server computer system of claim 1, wherein the automated teller machine session data is obtained, via the communications module, from at least one automated teller machine data source that includes at least one of an automated teller machine, an automated teller machine switch, and an automated teller machine host server.

6. The server computer system of claim 5, wherein the at least one automated teller machine data source is a plurality of automated teller machine data sources and the processor-executable instructions, when executed, further configure the processor to:
normalize and aggregate the automated teller machine session data.

7. The server computer system of claim 6, wherein when aggregating the automated teller machine session data, the processor-executable instructions, when executed, further configure the processor to:
analyze the automated teller machine session data to identify at least one commonality within the automated teller machine session data received from each of the automated teller machine data sources; and
aggregate the automated teller machine session data based at least on the identified commonality.

8. The server computer system of claim 7, wherein the at least one commonality includes at least one of a transaction identifier, a time, a date, an automated teller machine identifier, a customer identifier, or an account identifier.

9. The server computer system of claim 6, wherein the processor-executable instructions, when executed, further configure the processor to:
receive, in real-time and via the communications module from each one of the plurality of automated teller machine data sources, a signal indicating an end of an automated teller machine session; and
aggregate the automated teller machine session data based at least on the signal indicating the end of the automated teller machine session.

10. The server computer system of claim 1, wherein the processor-executable instructions, when executed, further configure the processor to:
obtain, via the communications module, mobile application data;
aggregate the mobile application data and the automated teller machine session data;
generate the first checksum based on the automated teller machine session data and the mobile application data; and
store the first checksum, the mobile application data and the automated teller machine session data in the database.

11. The server computer system of claim 1, wherein the automated teller session data includes at least one of automated teller machine screen shots, automated teller machine fault logs, automated teller machine receipts, automated teller machine deposits, cheque images, automated teller machine video, automated teller machine identifiers, surveillance video, surveillance images, or financial transaction data.

12. A computer-implemented method performed by a processor of a server computer system, the method comprising:
obtaining, via a communications module, automated teller machine session data;
generating a first checksum based on at least the automated teller machine session data; and
storing the first checksum and the automated teller machine session data in a database.

13. The computer-implemented method of claim 12, further comprising:
receiving a request to verify the automated teller machine session data;
retrieving the first checksum and the automated teller machine session data from the database;
generating a second checksum based on the retrieved automated teller machine session data; and
comparing the first checksum to the second checksum to verify the automated teller machine session data.

14. The computer-implemented method of claim 12, wherein the automated teller machine session data is obtained, via the communications module, from at least one automated teller machine data source that includes at least one of an automated teller machine, an automated teller machine switch, and an automated teller machine host server.

15. The computer-implemented method of claim 14, wherein the at least one automated teller machine data source is a plurality of automated teller machine data sources and the computer-implemented method further comprises:
normalizing and aggregating the automated teller machine session data.

16. The computer-implemented method of claim 15, wherein when aggregating the automated teller machine session data, the computer-implemented method further comprises:
analyzing the automated teller machine session data to identify at least one commonality within the automated teller machine session data received from each of the automated teller machine data sources; and
aggregating the automated teller machine session data based at least on the identified commonality.

17. The computer-implemented method of claim 16, wherein the at least one commonality includes at least one of a transaction identifier, a time, a date, an automated teller machine identifier, a customer identifier, or an account identifier.

18. The computer-implemented method of claim 15, further comprising:
receiving, in real-time and via the communications module from each one of the plurality of automated teller machine data sources, a signal indicating an end of an automated teller machine session; and
aggregating the automated teller machine session data based at least on the signal indicating the end of the automated teller machine session.

19. The computer-implemented method of claim 13, further comprising:
obtaining, via the communications module, mobile application data;
aggregating the mobile application data and the automated teller machine session data;
generating the first checksum based on the automated teller machine session data and the mobile application data; and
storing the first checksum, the mobile application data and the automated teller machine session data in the database.

20. A non-transitory computer-readable storage medium storing instructions that when executed by a processor of a computing system cause the computing system to:
obtain, via a communications module, automated teller machine session data;
generate a first checksum based on at least the automated teller machine session data; and
store the first checksum and the automated teller machine session data in a database.
